(19) United States
(12) Patent Application Publication
(10) Pub. No.: US 2016/0076880 A1
(43) Pub. Date: Mar. 17, 2016

(54) COMPUTING DEVICE AND METHOD FOR PROCESSING POINT CLOUDS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); LING ZHANG, Shenzhen (CN); HENG ZHANG, Shenzhen (CN)

(21) Appl. No.: 14/584,496

(22) Filed: Dec. 29, 2014

(30) Foreign Application Priority Data
Sep. 11, 2014 (CN) 201410462365.6

(51) Int. Cl. G01B 11/24

(52) U.S. Cl. CPC G01B 11/24

(57) ABSTRACT

A computing device and a method process point clouds of an object. The computing device controls a rotating device connected to the computing device to rotate to one or more rotation angles of the rotating device. The computing device generates a first coordinate system and one or more second coordinate systems according to one or more rotation angles of the rotating device, and obtains a point cloud of an object based on each of the second coordinate systems from a scanner of the rotating device. The computing device converts the point cloud of the object based on each of the second coordinate systems to a point cloud of the object based on the first coordinate system, and joints all point clouds of the object based on the first coordinate system.

### CROSS-REFERENCE TO RELATED APPLICATIONS

This application claims priority to Chinese Patent Application No. 201410462365.6 filed on Sep. 11, 2014, the contents of which are incorporated by reference herein.

### FIELD

The subject matter herein relates to point cloud technology, and particularly to a computing device and a method for processing point clouds of an object.

### BACKGROUND

Point clouds can be created by a scanner. A measurement device can measure a large number of points to generate point clouds by scanning a surface of an object (e.g., a component of a mobile phone). The point cloud represents a set of points that the measurement device has measured. However, each point cloud can include its own coordinate system, which may make it difficult to joint more than one point cloud of the object.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 is a block diagram of an example embodiment of a point cloud processing system included in the computing device.

FIG. 3 is a diagrammatic view of an example of a first coordinate system and a second coordinate system.

FIG. 4 is a flowchart of an example embodiment of a method for processing point clouds.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

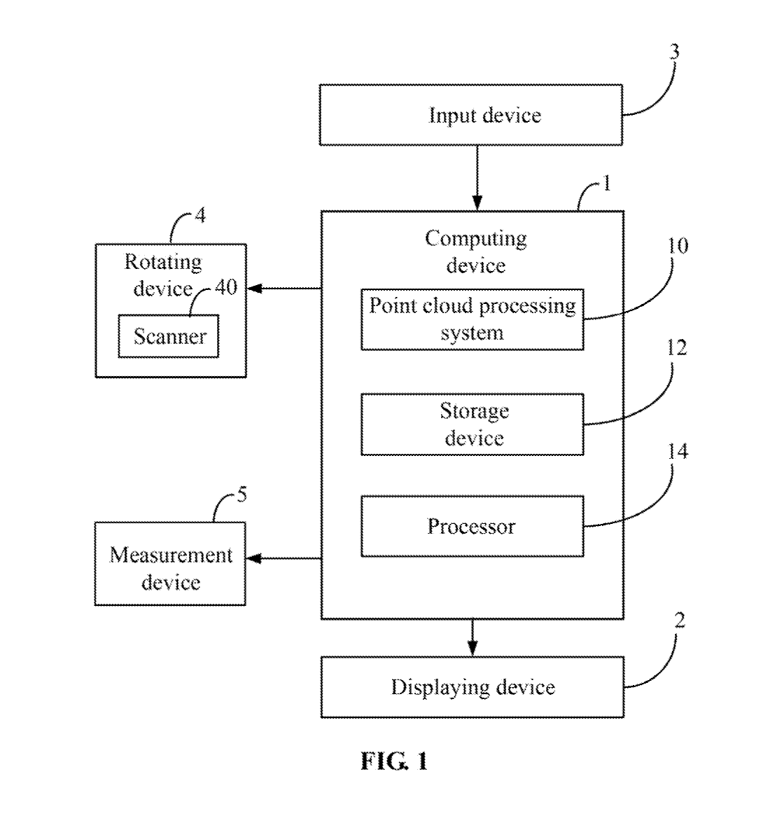

FIG. 1 illustrates a block diagram of an example embodiment of a computing device 1. In the embodiment, the computing device 1 provides various functional connections to connect with a displaying device 2, an input device 3, a rotating device 4, and a measurement machine 5. The computing device 1 provides a user interface, which is displayed on the displaying device 2. One or more operations of the computing device 1 can be controlled by a user through the user interface. For example, the user may input an ID and a password using the input device 3 (e.g., a keyboard and a mouse) into the user interface to access the computing device 1. The rotating device 4 includes a scanner 40, and the rotating device 4 can rotate the scanner 40 with different angles. The scanner 40 is used to scan an object (for example, a component of a mobile phone) located on the measurement machine 5 to obtain point clouds of the object. The point clouds consist of a large number of points which are represented by three-dimensional values. That is, each point in the point clouds includes an X-axis value, a Y-axis value and a Z-axis value. Furthermore, the scanner 4 is used to capture images of the object at different angles. The displaying device 2 further displays the point clouds of the object and the images of the object, so that point clouds of the object and the images of the object can be visually checked by the user. The computing device 1 can be, but is not limited to, a tablet computer, a server, a personal computer or any other computing device. The scanner 4 can be, but is not limited to, a three-dimensional scanner capable of emitting light which is projected onto the object located on the measurement machine 5. The measurement machine 5 can be, but is not limited to, a CNC machine. In the example embodiment, the computing device 1 includes, but is not limited to, a point cloud processing system 10, a storage device 12, and at least one processor 14. FIG. 1 illustrates only one example of the computing device 1, and other examples can comprise more or fewer components than those shown in the embodiment, or have a different configuration of the various components.

In at least one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 14 can be a central processing unit (CPU), a microprocessor, or other data processor chip that performs functions of the computing device 1.

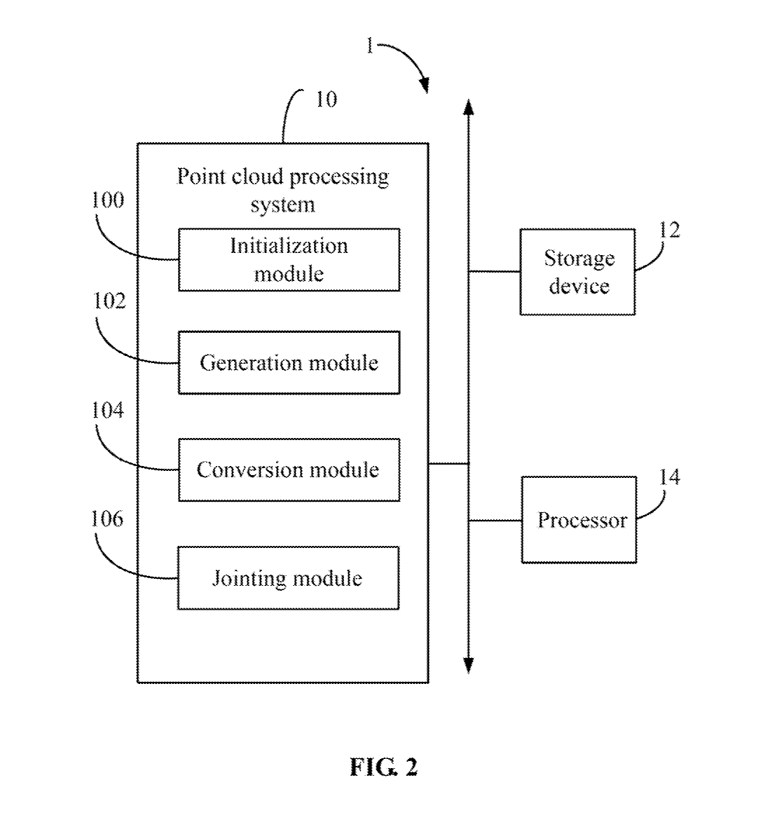

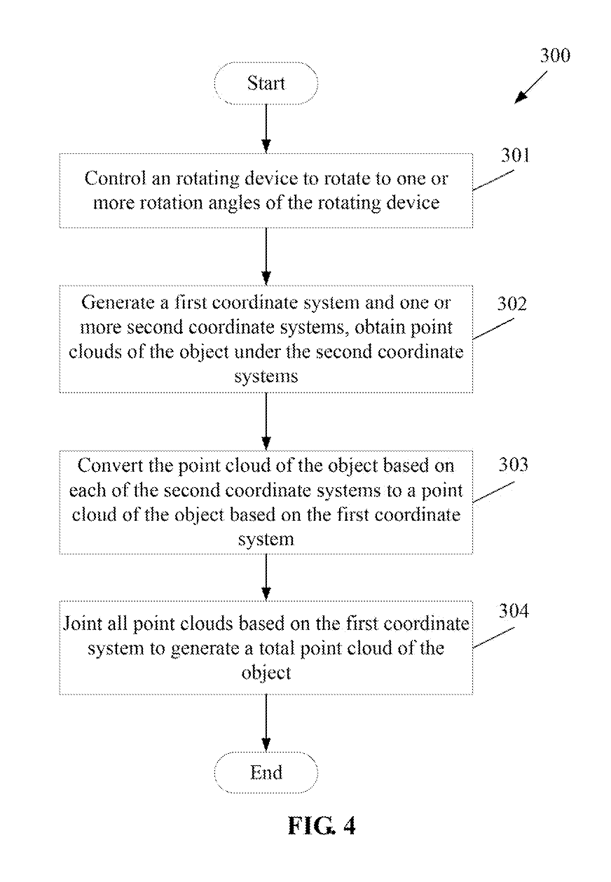

FIG. 2 illustrates a block diagram of an example embodiment of the point cloud processing system 10 included in the computing device 1. In at least one embodiment, the point cloud processing system 10 can include, but is not limited to, an initialization module 100, a generation module 102, a conversion module 104, and a jointing module 106. The modules 100-106 can comprise computerized instructions in the form of one or more computer-readable programs that can be stored in a non-transitory computer-readable medium, such as the storage device 12, and be executed by the at least one processor 14 of the computing device 1. Detailed descriptions of functions of the modules are given below in reference to FIG. 4.

FIG. 4 illustrates a flowchart of an example embodiment of a method for processing point clouds. In an example embodiment, the method is performed by execution of computer-readable software program codes or instructions by at least one processor of a computing device.

Referring to FIG. 4, a flowchart is presented in accordance with an example embodiment. The method 300 is provided by way of example, as there are a variety of ways to carry out the method. The method 300 described below can be carried out using the configurations illustrated in FIGS. 1-4, for example, and various elements of these figures are referenced in explaining example method 300. Each block shown in FIG. 4 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

At block 301, the initialization module 100 controls the rotating device 4 to rotate to one or more rotation angles of the rotating device 4. In at least one embodiment, the rotating device 4 includes an angular transducer to detect each rotation angle of the rotating device 4. The rotating device 4 is controlled to stop rotating when the rotating device 4 is rotated to the rotation angles.

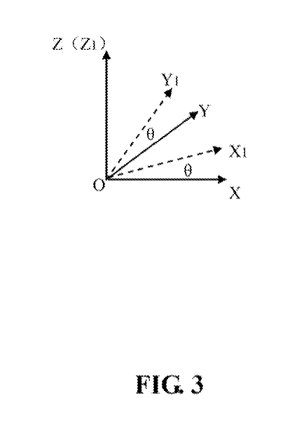

At block 302, the generation module 102 generates a first coordinate system and one or more second coordinate systems according to one or more rotation angles of the rotating device 4, obtains point clouds of the object based on the second coordinate systems from a scanner 40 of the rotating device 4. The first coordinate system is generated as follow: a center point of a platform of the rotating device 4 is an origin of coordinate, a Z axis of the first coordinate system is vertical to a surface of the platform of the rotating device 4, a Y axis and an X axis of the first coordinate system are parallel with the surface of the platform. The first coordinate system rotates one rotation angle when the rotating device 4 rotates one rotation angle. The second coordinate system is generated when the first coordinate system rotates one rotation angle. That is, each second coordinate system is related to one rotation angle. If the first coordinate system rotates ten rotation angles, and ten second coordinate system are generated. The first coordinate system and all second coordinate systems share an origin of coordinate and one axis (for example, a Z axis), as shown in FIG. 3. For example, as shown in FIG. 3, the first coordinate system OXYZ and the second coordinate system OX1Y1Z1 shares the same Z axis and the origin of coordinate O. The first coordinate system OXYZ rotates the rotation angle θ to generate the second coordinate system OX1Y1Z1. The scanner 40 scans the object at a rotation angle to obtain a point cloud of the object based on the second coordinate system corresponding to the rotation angle. That is, if the first coordinate system rotates ten rotation angles, ten point clouds of the object are obtained.

At block 303, the conversion module 104 converts each point cloud of the object based on the second coordinate system to a point cloud of the object based on the first coordinate system. In at least one embodiment, a first matrix is generated for the first coordinate system, which includes four rows and four columns, such as

$$a 1 = [ \begin{matrix}1 , 0 , 0 , 0 \\ 0 , 1 , 0 , 0 \\ 0 , 0 , 1 , 0 \\ 0 , 0 , 0 , 1\end{matrix} ] .$$

A second matrix is generated for a second coordinate system according to the rotation angle θ, which includes four rows and four columns, such as

$$a 2 = [ \begin{matrix}1 * sin θ , 0 , 0 , 0 \\ 0 , 1 * cos θ , 0 , 0 \\ 0 , 0 , 1 * tan θ , 0 \\ 0 , 0 , 0 , 1 \end{matrix} ] .$$

The point clouds of the object are converted from the second coordinate system to the first coordinate system using a formula as follow: A1=A2*a2, where A1 is an array including coordinates of each point of the point clouds of the object based on the first coordinate system and the A2 is an array including coordinates of each point of the point clouds of the object based on the second coordinate system.

At block 304, the jointing module 106 joints all point clouds based on the first coordinate system to generate a total point cloud of the object. In the embodiment, the total point cloud of the object is generated by deleting repeated points of the point clouds from the first coordinate system, and integrating undeleted points of the point clouds in the first coordinate system to generate the total point cloud of the object. Each of the repeated points has the same coordinates with at least another point. In at least one embodiment, if all point clouds of the object are jointed under the first coordinate system, and one or more repeated points are searched from all point clouds of the object.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device comprising:
at least one processor; and
a storage device that stores one or more programs which, when executed by the at least one processor, cause the at least one processor to:
control a rotating device connected to the computing device to rotate to one or more rotation angles of the rotating device;
generate a first coordinate system and one or more second coordinate systems according to one or more rotation angles of the rotating device;
obtain a point cloud of an object based on each of the one or more second coordinate systems from a scanner of the rotating device;
convert the point cloud of the object based on each of the one or more second coordinate systems to a point cloud of the object based on the first coordinate system; and
joint all point clouds of the object based on the first coordinate system to generate a total point cloud of the object.

2. The computing device of claim 1, wherein the first coordinate system rotates one rotation angle when the rotating device rotates one rotation angle.

3. The computing device of claim 1, wherein the second coordinate system is generated when the first coordinate system rotates one rotation angle, and each of the second coordinate systems is related to one rotation angle.

4. The computing device of claim 3, wherein the second coordinate systems share an origin of coordinate and one axis of the first coordinate system.

5. The computing device of claim 3, wherein the scanner scans the object at a rotation angle to obtain a point cloud of the object based on each of the second coordinate systems corresponding to the rotation angle.

6. The computing device of claim 1, wherein the total point cloud of the object is generated by deleting repeated points of the point clouds from the first coordinate system, and integrating undeleted points of the point clouds in the first coordinate system to generate the total point cloud of the object.

7. A computer-based method for processing point clouds using a computing device, the method comprising:
controlling a rotating device connected to the computing device to rotate to one or more rotation angles of the rotating device;
generating a first coordinate system and one or more second coordinate systems according to one or more rotation angles of the rotating device;
obtaining a point cloud of an object based on each of the second coordinate systems from a scanner of the rotating device;
converting the point cloud of the object based on each of the second coordinate systems to a point cloud of the object based on the first coordinate system; and
jointing all point clouds of the object based on the first coordinate system to generate a total point cloud of the object.

8. The method of claim 7, wherein the first coordinate system rotates one rotation angle when the rotating device rotates one rotation angle.

9. The method of claim 7, wherein the second coordinate system is generated when the first coordinate system rotates one rotation angle, and each of the second coordinate systems is related to one rotation angle.

10. The method of claim 9, wherein the second coordinate systems share an origin of coordinate and one axis of the first coordinate system.

11. The method of claim 9, wherein the scanner scans the object at a rotation angle to obtain a point cloud of the object based on each of the second coordinate systems corresponding to the rotation angle.

12. The method of claim 7, wherein the total point cloud of the object is generated by deleting repeated points of the point clouds from the first coordinate system, and integrating undeleted points of the point clouds in the first coordinate system to generate the total point cloud of the object.

13. A non-transitory computer-readable medium having stored thereon instructions that, when executed by at least one processor of a computing device, causing the computing device to perform a method for processing point clouds, the method comprising:
controlling a rotating device connected to the computing device to rotate to one or more rotation angles of the rotating device;
generating a first coordinate system and one or more second coordinate systems according to one or more rotation angles of the rotating device;
obtaining a point cloud of an object based on each of the second coordinate systems from a scanner of the rotating device;
converting the point cloud of the object based on each of the second coordinate systems to a point cloud of the object based on the first coordinate system; and
jointing all point clouds of the object based on the first coordinate system to generate a total point cloud of the object.

14. The non-transitory computer-readable medium of claim 13, wherein the first coordinate system rotates one rotation angle when the rotating device rotates one rotation angle.

15. The non-transitory computer-readable medium of claim 13, wherein the second coordinate system is generated when the first coordinate system rotates one rotation angle, and each of the second coordinate systems is related to one rotation angle.

16. The non-transitory computer-readable medium of claim 15, wherein the second coordinate systems share an origin of coordinate and one axis of the first coordinate system.

17. The non-transitory computer-readable medium of claim 15, wherein the scanner scans the object at a rotation angle to obtain a point cloud of the object based on each of the second coordinate systems corresponding to the rotation angle.

18. The non-transitory computer-readable medium of claim 13, wherein the total point cloud of the object is generated by deleting repeated points of the point clouds from the first coordinate system, and integrating undeleted points of the point clouds in the first coordinate system to generate the total point cloud of the object.
